(19) United States
(12) Patent Application Publication
(10) Pub. No.: US 2010/0253034 A1
(43) Pub. Date: Oct. 7, 2010

(54) QUICK SWAP FENDER

(76) Inventors: David Crismon, Riverton, UT (US); Ken Lewis, St. George, UT (US); Anthony Nethercott, St. George, UT (US)

Correspondence Address: CARLSON, GASKEY & OLDS, P.C., 400 WEST MAPLE ROAD, SUITE 350, BIRMINGHAM, MI, 48009, US

(21) Appl. No.: 12/755,698

(22) Filed: Apr. 7, 2010

Related U.S. Application Data
(60) Provisional application No. 61/167,256, filed on Apr. 7, 2009.

(51) Int. Cl. B62D 25/18

(52) U.S. Cl. 280/154

(57) ABSTRACT

A quick swap fender includes an intermediate mounting structure having securing features that are configured to secure the intermediate mounting structure to a body panel. The intermediate mounting structure includes a first locating feature. A detachable fender includes a second locating feature that is configured to cooperate with the first locating feature in an installed position. The first and second locating features retain the detachable fender relative to the intermediate mounting structure in a desired position, which may correspond to a typical fender “street use” position. A fastening device removably secures the detachable fender relative to the intermediate mounting structure in the installed position.

This application claims priority to U.S. application Ser. No. 61/167,256, which was filed on Apr. 7, 2009.

### BACKGROUND

This disclosure relates to a fender that can be quickly connected and disconnected to a vehicle.

The wheels of a vehicle typically must be surrounded by a structure for the vehicle to be legal for street use. Some vehicles are used on the street as well as crawling or off-road for recreational purposes. When the vehicle is used off-road, it may be desirable to remove the fenders from the vehicle to provide improved visibility to the vehicle operator and permit a greater amount of wheel travel. Removing and reinstalling the fenders when switching, or swapping, between street and off-road uses can be time consuming. Moreover, the factory fenders may become damaged or broken when removing and reinstalling them frequently.

### SUMMARY

A quick swap fender includes an intermediate mounting structure having securing features that are configured to secure the intermediate mounting structure to a body panel. The intermediate mounting structure includes a first locating feature. A detachable fender includes a second locating feature that is configured to cooperate with the first locating feature in an installed position. The first and second locating features retain the detachable fender relative to the intermediate mounting structure in a desired position, which may correspond to a typical fender “street use” position. A fastening device removably secures the detachable fender relative to the intermediate mounting structure in the installed position.

### BRIEF DESCRIPTION OF THE DRAWINGS

The disclosure can be further understood by reference to the following detailed description when considered in connection with the accompanying drawings wherein:

FIG. 1 is an exploded perspective view of one example fender arrangement.

FIG. 2 is an exploded perspective view of the fender arrangement shown in FIG. 1.

FIG. 3A is a top perspective view of the example fender arrangement.

FIG. 3B is side perspective view of the detachable fender shown in FIG. 3A.

FIG. 4 is a bottom perspective view of the detachable fender shown in FIG. 3A.

FIG. 5 is a cross-sectional view of the detachable fender in the installed position.

FIG. 6 is a cross-sectional view of another example arrangement with the fender in the installed position.

FIG. 7 is another example detachable fender having a strap used to removeably secure the detachable fending to an intermediate mounting structure.

FIG. 8 is a perspective view of the detachable fender shown in FIG. 7 with the strap received in a slot in the intermediate mounting structure during installation of the detachable fender onto the intermediate mounting structure.

FIG. 9 a cross-sectional view of the strap in the installed position taken along line 9-9 in FIG. 8.

### DETAILED DESCRIPTION

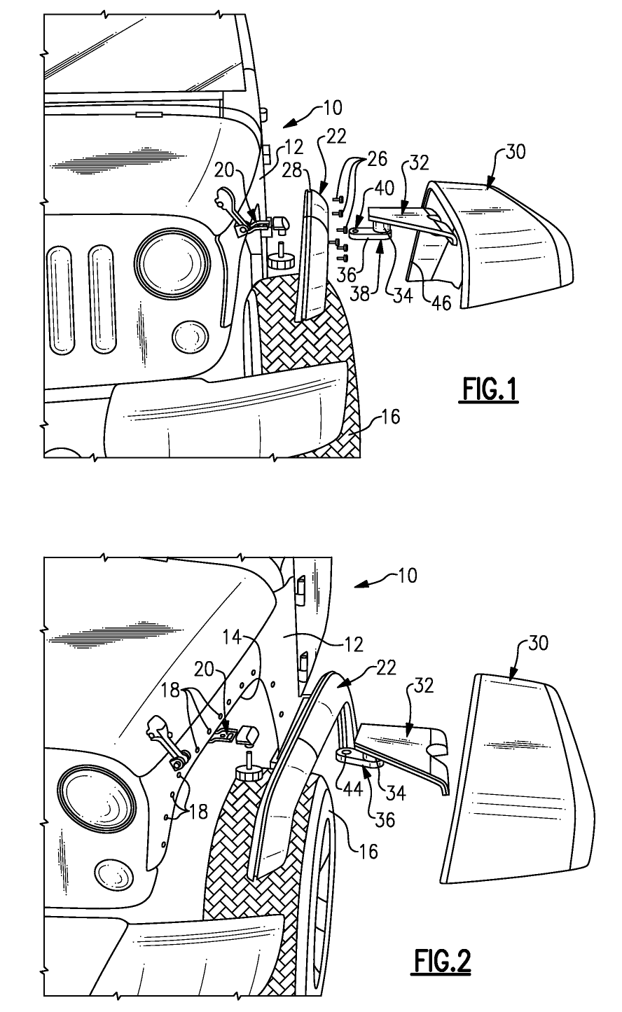

Referring to FIGS. 1 and 2, a vehicle 10 includes a body panel 12 that provides a wheel well 14 for housing a wheel 16 at each of the four corners of the vehicle 10. The vehicle 10 is illustrated as a 2007 and later model Jeep, however, it should be understood that the disclosed fender arrangement may be used with other model years and other vehicles. The body panel 12 includes multiple holes 18 arranged about a perimeter of the wheel well 14. Typically, a factory fender, which at least partially surrounds the wheel 16, is secured directly to the body panel 12 by fasteners received within the holes 18 and corresponding holes in the fender. A bracket 20 permanently secured to the body panel 12 at the vehicle OEM is also used to support the factory fender.

At times, such as in preparation for off-road use, it is desirable for the vehicle operator to remove the factory fender, which is cumbersome in that all of the fasteners must be removed using special tools. Accordingly, it is desirable to provide a quick swap fender that enables a fender to be quickly installed and removed.

The disclosed quick swap fender replaces the factory fender with an intermediate mounting structure 22 that removably supports a detachable fender 30 using a fastening scheme, or attaching feature, that may include one or more fastening devices. The intermediate mounting structure 22 is intended to be generally permanently mounted to the body panel 12. That is, the intermediate mounting structure 22 remains secured to the vehicle 10 while the detachable fender 30 is installed onto and removed from the intermediate mounting structure 22, as desired.

The intermediate mounting structure 22 is secured to the body panel 12 using fasteners 26 received in the holes 18 and corresponding holes 24 in the intermediate mounting structure 22, which are provided on an arc-shaped flange of the intermediate mounting structure 22. The fasteners 26 may be threaded fastening elements, or expandable rivets, for example. Moreover, the fasteners 26 may be integrated with the intermediate mounting structure 22. The outer surface of the intermediate mounting structure 22 has a curved, aesthetic appearance that provides a small fender-like look when the detachable fender 30 is removed.

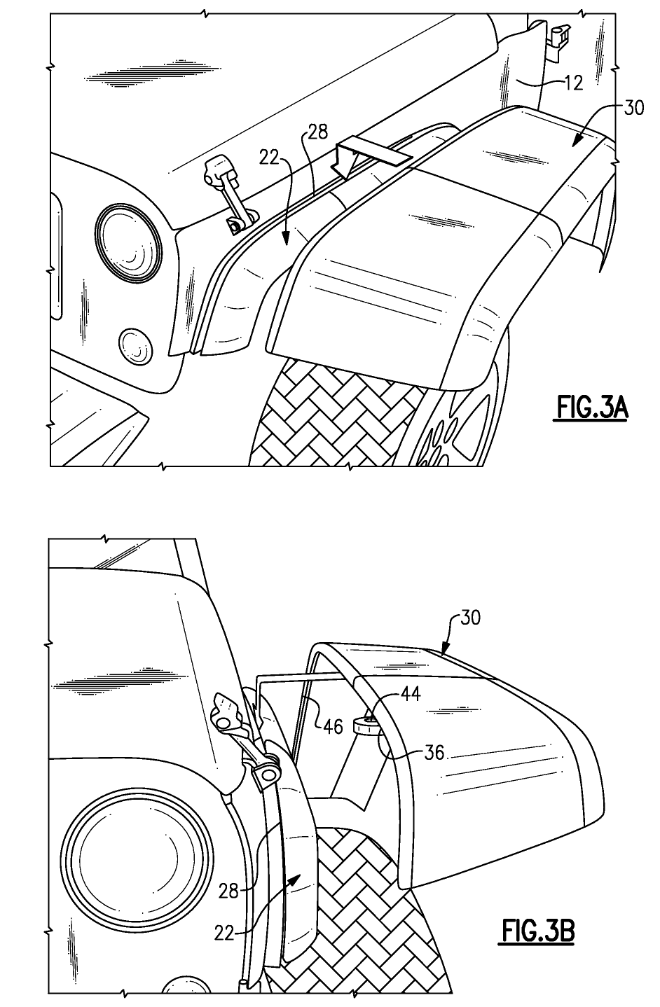

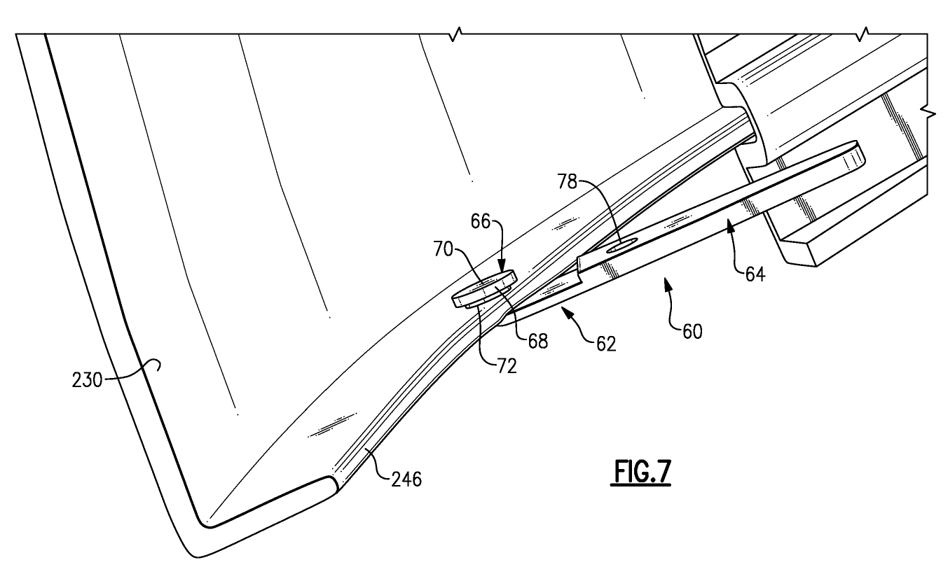

Complementary locating features are provided on the intermediate mounting structure 22 and the detachable fender 30. In one example, the intermediate mounting structure 22 includes a groove 28 that receives a lip 46 (FIGS. 3A and 3B) provided on the detachable fender 30 when the detachable fender 30 is in the installed position (best shown in FIG. 5).

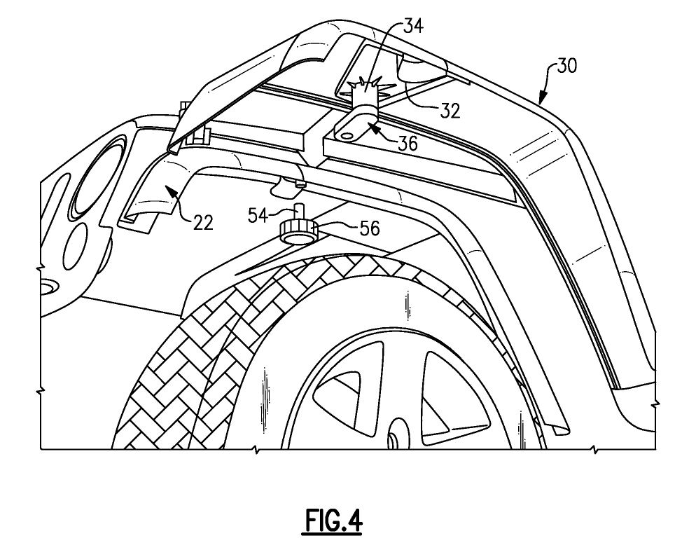

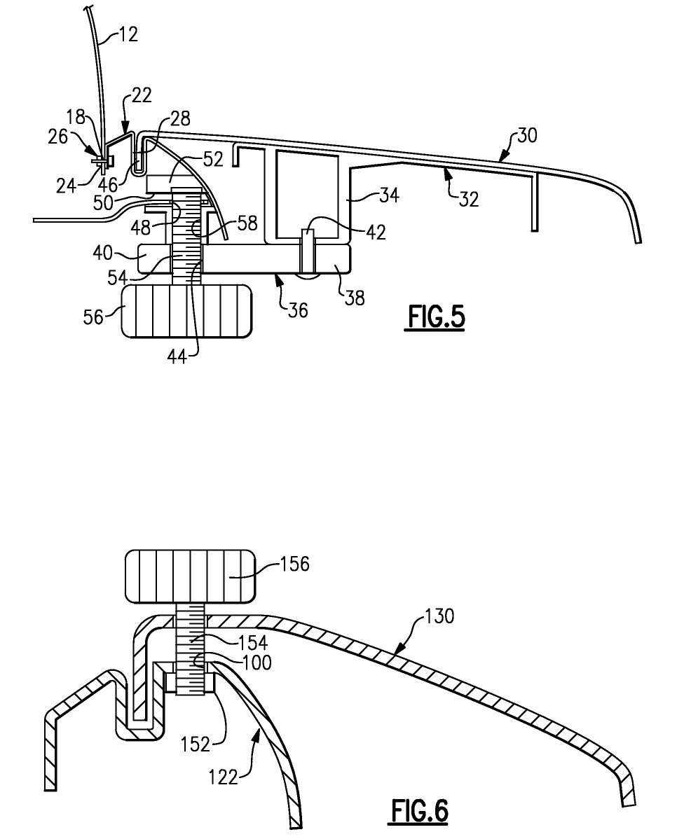

A support 32, including a boss 34, is secured to an underside of the detachable fender 30, best shown in FIG. 4, by welds or adhesive. In one example, the detachable fender 30 is a vacuum formed plastic, and the intermediate structure 22 and support 32 is an injection molded plastic. The detachable fender 30 may be manufactured in different widths to accommodate different size tires.

The boss 34 provides a first fastening device and supports a rotatable arm 36 by a pivot 42 at a first end 38. A second end 40 of the arm 36 includes a hole 44. The second end 40 is rotatable about the pivot 42 to enable the detachable fender 30 to be installed from above without interfering with the bracket 20.

In operation, the arm 36 is rotated from an installation position (illustrated in FIG. 2) to a retracted position that is approximately at least 90° from the installed position. The detachable fender 30 is lowered onto the intermediate mounting structure 22, such that the lip 46 is received in the groove 28 (see FIG. 5). The arm 36 is rotated about the pivot 42 from the retracted position to the installed position.

In one example, the fastening device includes a nut 52 having a pocket 50. The nut 52 slides over the bracket 20, such that an end of the bracket is received within the pocket 50. A portion of the nut 52 includes a threaded hole 58 that aligns with an aperture 48 in the bracket 20. The nut 52 is installed onto the bracket 20 before installing the intermediate mounting structure 22 onto the body panel 12. The outer wall of the intermediate mounting structure 22 retains the nut 52 on the bracket 20. The hole 44 aligns with the threaded hole 58 with the arm 36 in the installed position. A threaded element 54 having a knob 56 is received within the hole 44 and threaded hole 58 to secure the detachable fender 30 to the bracket 20.

In another example (FIG. 6), the body panel 12 lacks the bracket 20. The detachable fender 130 is secured to the intermediate mounting structure 122 by the knob 156 and fastening element 154, which is received in hole 100, and the nut 152. Such an arrangement may be suitable for vehicles without the bracket.

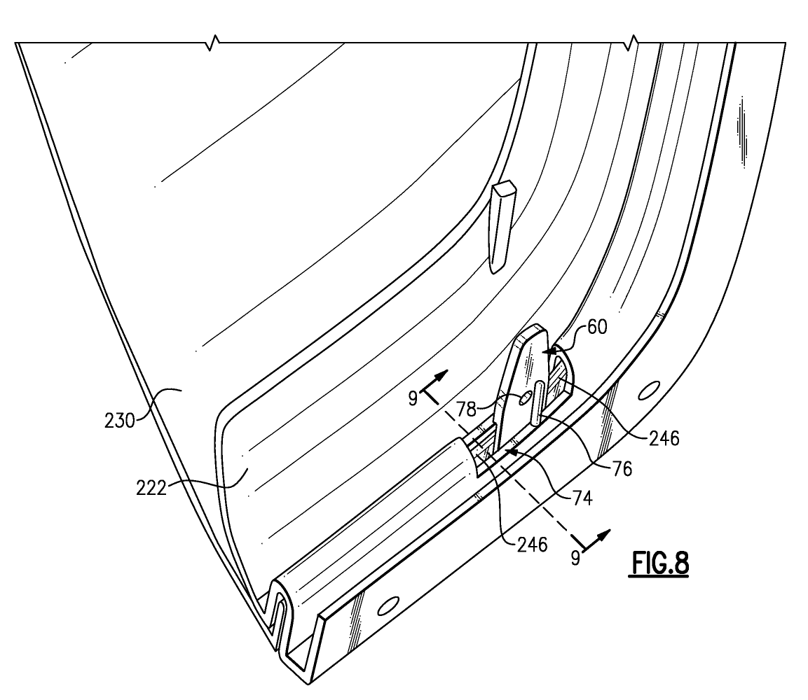

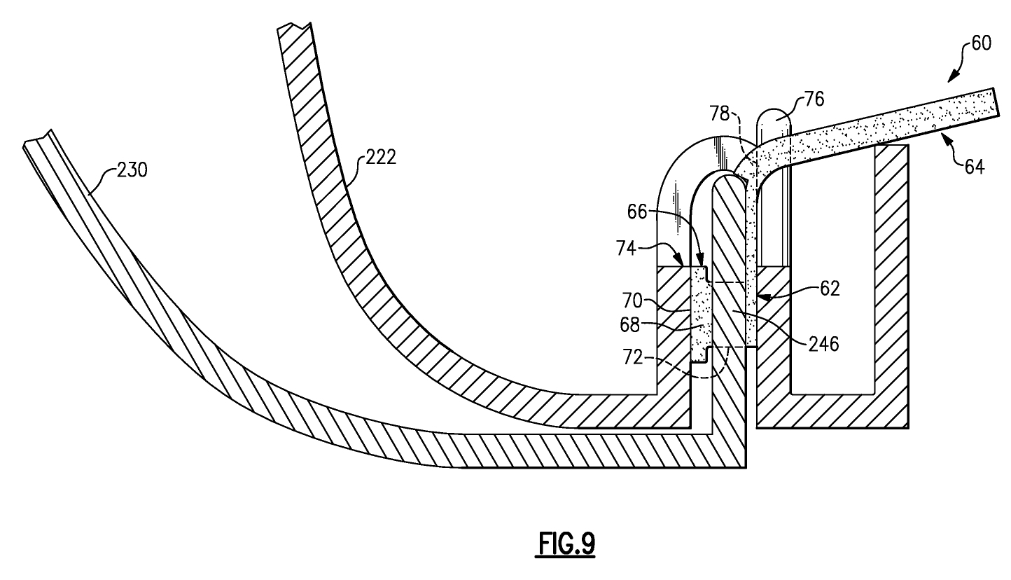

Referring to FIGS. 7-9, another example detachable fender 230 is shown. A flexible strap 60, which may be constructed from a rubber material, for example, includes first and second opposing ends 62, 64. The first end 62 includes a connection 66 that secures the strap 60 to the detachable fender 230. The connection 66 includes a neck 68 extending from the first end 62 to a head 70. The neck 68 is received in an aperture 72 in the detachable fender 30, and the head 70 is larger than the aperture 72 to prevent the connections 66 from pulling out of the aperture 72 during use.

To install the detachable fender 230 to the intermediate mounting structure 222, the detachable fender 230 is slid onto the intermediate mounting structure 222 such that the lip 246 is received in the groove 228. The strap 60, which provides a second fastening device, is guided through a slot 74 in the intermediate mounting structure 222. A pin or boss 76 extends from the intermediate mounting structure 222. The second end 64 is stretched over the intermediate mounting structure 222 so that the pin 76 is aligned with and received within the hole 78, as shown in FIG. 9, in the installed position. Multiple straps 60 may be provided along the perimeter of the detachable fender 230 to secure the detachable fender to corresponding pins 76 on the intermediate structure 22. The straps can be used instead of or in addition to the nut 52 and threaded element 54.

Although an example embodiment has been disclosed, a worker of ordinary skill in this art would recognize that certain modifications would come within the scope of the claims. For that reason, the following claims should be studied to determine their true scope and content.

What is claimed is:

1. A quick swap fender comprising:
an intermediate mounting structure with a securing feature configured to be secured to a body panel, the intermediate mounting structure including a first locating feature;
a detachable fender including a second locating feature configured to cooperate with the first locating feature in an installed position for retaining the detachable fender relative to the intermediate mounting structure in a desired position; and
a fastening device configured to removably secure the detachable fender relative to the intermediate mounting structure in the installed position.

2. The fender according to claim 1, wherein the securing feature includes holes in the intermediate structure configured to correspond to holes in the body panel, and fasteners configured to be disposed within the body panel and intermediate structure holes to secure the intermediate mounting structure to the body panel.

3. The fender according to claim 1, wherein the first and second locating features include a lip and a correspondingly shaped groove receiving the lip in the installed position.

4. The fender according to claim 3, wherein the first locating feature is the groove.

5. The fender according to claim 1, wherein the fastening device is different than the first and second locating features.

6. The fender according to claim 5, wherein the fastening feature includes a nut configured to be supported relative to the body panel and a threaded element receiving a hole in the detachable fender and secured to the nut in the installed position.

7. The fender according to claim 6, wherein the detachable fender includes a support having a rotatable arm providing the hole.

8. The fender according to claim 5, wherein the fastening device includes a flexible strap secured to one of the intermediate mounting structure and the detachable fender and cooperating with a structure on the other of the intermediate mounting structure and the detachable fender in the installed position.

9. The fender according to claim 8, wherein the strap is secured to the detachable fender, and the intermediate mounting structure includes a slot, with the strap disposed within the slot in the installed position.

10. The fender according to claim 9, wherein the strap includes a hole, and the intermediate mounting structure includes a pin received within the hole in the installed position.

11. The fender according to claim 9, wherein the strap includes a connection secured to the detachable fender, the connection includes a neck disposed in a hole in the detachable fender and a head on the neck having a larger diameter than the hole retaining the strap to the detachable fender.

12. A method of securing a fender to a vehicle comprising the steps of:
securing an intermediate mounting structure about a vehicle wheel well body panel; and
removable mounting a detachable fender to the intermediate mounting structure with complementary first and second locating features respectively provided on the intermediate mounting structure and the detachable fender.

13. The method according to claim 12, wherein the securing step includes inserting fasteners through corresponding holes in the intermediate mounting structure and the body panel.

14. The method according to claim 12, wherein mounting step includes providing the first and second locating features respectively include a lip and a groove with the lip received in the groove.

15. The method according to claim 12, comprising the step of fastening the detachable fender relative to the intermediate mounting structure using a fastening device that is different than the first and second locating features.

16. The method according to claim 15, wherein the fastening step includes providing a nut operatively mounted to the body panel and threadingly securing an element to the nut.

17. The method according to claim 15, wherein the fastening step includes pulling a strap over a pin, the strap provided on one of the intermediate mounting structure and the detachable fender.

18. A vehicle quick swap fender comprising:
a body panel;
an intermediate mounting structure secured to the body panel, the intermediate mounting structure including a first locating feature;
a detachable fender including second locating feature cooperating with the first locating feature in an installed position for retaining the detachable fender relative to the intermediate mounting structure in a desired position; and
a fastening device removably securing the detachable fender relative to the body panel in the installed position.
